(19) United States
(12) Patent Application Publication
(10) Pub. No.: US 2024/0176785 A1
(43) Pub. Date: May 30, 2024

(54) SYSTEM AND METHOD TO IDENTIFY AND QUANTIFY MONOTONY IN COMPUTER RELATED PROCESSES

(71) Applicant: Nice Ltd., Ra'anana (IN)

(72) Inventors: Darshan AMBHAIKAR, Pune (IN); Seemit Vijay SHAH, Pune (IN); Yuvraj Amrutrao SAWANT, Pune (IN); Nick MARTIN, Plano (IN)

(73) Assignee: Nice Ltd., Ra'anana (IN)

(21) Appl. No.: 18/071,008

(22) Filed: Nov. 29, 2022

(51) Int. Cl. G06F 16/2457; G06F 16/22

(52) U.S. Cl. CPC G06F 16/24573; G06F 16/2272; G06F 16/2358

(57) ABSTRACT

A computerized system and method may quantify a level or degree of monotony associated with the execution of repetitive tasks involving a plurality of computing devices—and may accordingly determine or choose a task schedule for which the smallest degree of monotony is calculated. A computerized system comprising one or more processors, a communication interface to communicate via a communication network with remote computing devices, and a memory including data items describing tasks involving the remote computing devices, may be used for selecting remote computers based on the stored data items; calculate monotony indices for the selected computing devices based on, e.g., a plurality of tasks and corresponding time windows (in which, e.g., the tasks were performed or executed); automatically documenting the calculated monotony indices in a database; and transmitting instructions to automatically execute computer operations on a remote computer based on calculated monotony indices.

### FIELD OF THE INVENTION

The present invention relates to the field of identifying and quantifying monotony, and associated degradations in performance statistics, among a plurality of remotely connected computer systems within a given timeframe.

### BACKGROUND OF THE INVENTION

Monotony, in computer-related tasks is known to be associated with, e.g., repetitiveness of tasks, and is a top factor in affecting, for example, the engagement and performance of people associated with these tasks. In call or contact centers, for instance, primary tasks and responsibilities may include using computer systems to identify customer needs, resolve issues and provide solutions—in addition to interacting with computer systems in handling inbound and outbound calls, chats, emails, and the like. Such responsibilities often involve the serial, repetitive execution of highly similar tasks, which inherently contributes to degradation in performance and/or output quality. Contact center agents, for example, are required to dedicate many hours to phone-based tasks or interactions with callers and/or customers while adhering to rigid telemarketing scripts which limit opportunities for creativity and innovation—and are thus prone to be highly affected by monotony.

There is thus a need for solutions for identifying and quantifying monotony, for example in order to support workforce management (WFM) computer programs and/or applications and/or help supervisors in assessing the degree of monotony a given working unit or entity (such as a contact center employee) is subjected to as part of its working routine.

### SUMMARY OF THE INVENTION

A computerized system and method may measure and/or assess and/or quantify a level or degree of monotony associated with the execution of repetitive tasks, or of tasks of a similar type, involving a remote computing device or a plurality of computing devices. In some embodiments a process may accordingly determine or choose a task schedule (e.g., for computerized tasks) for which the smallest degree or amount of monotony is expected or calculated. A computerized system including one or more processors, a communication interface to communicate via a communication network with remote computing devices, and a memory including a data store of a plurality of data items—which may, for example, describe a plurality of tasks involving the remote computing devices—may be used for selecting remote computers based on the stored data items; calculate monotony indices for the selected computing devices based on, e.g., a plurality of tasks and corresponding time windows (in which, for example, the tasks were performed or executed); automatically documenting the calculated monotony indices in a database; and transmitting instructions to automatically execute computer operations on a remote computer based on calculated monotony indices.

Embodiments may include generating new data items (which may be, for example, reports describing the execution or performing of tasks by remote computers, or data items including task scheduling instructions and/or notifications and/or alerts, in accordance with the contents of the present disclosure), and/or scheduling the periodic execution of various steps included in a monotony assessment or quantification procedure, based on the contents of stored data items, on a plurality of properties and/or statistics which may be derived from them, and on a plurality of predetermined conditions and/or thresholds.

### BRIEF DESCRIPTION OF THE DRAWINGS

Non-limiting examples of embodiments of the disclosure are described below with reference to figures attached hereto. Dimensions of features shown in the figures are chosen for convenience and clarity of presentation and are not necessarily shown to scale. The subject matter regarded as the invention is particularly pointed out and distinctly claimed in the concluding portion of the specification. The invention, however, both as to organization and method of operation, together with objects, features, and advantages thereof, can be understood by reference to the following detailed description when read with the accompanied drawings. Embodiments of the invention are illustrated by way of example and not limitation in the figures of the accompanying drawings, in which like reference numerals indicate corresponding, analogous or similar elements, and in which:

FIG. 1 is a high-level block diagram of an exemplary computing device which may be used with embodiments of the invention.

FIG. 2 illustrates a remote computer device connected via a communication or data network to a computerized system which may be used in some embodiments of the invention.

FIG. 3 is a high-level block diagram which illustrates an example architecture of a system for identifying and/or quantifying monotony according to some embodiments of the invention.

FIG. 4 is a flow diagram illustrating an example procedure for identifying and/or quantifying monotony according to some embodiments of the invention.

FIG. 5 illustrates an example scheduled execution of a procedure for identifying and/or quantifying monotony by a scheduler according to some embodiments of the invention.

FIG. 6 is a flow diagram of an example monotony interaction index (MII) calculation procedure according to some embodiments of the invention.

FIG. 7 shows a flow diagram of an example monotony frequency index (MFI) calculation procedure according to some embodiments of the invention.

FIG. 8 is a flow diagram of an example monotony index (MI) calculation procedure according to some embodiments of the invention.

FIG. 9 depicts an example visualization of a block scheduling approach which may be used in some embodiments of the invention

FIG. 10 is a flowchart depicting a simple method for quantifying monotony according to some embodiments of the invention.

It will be appreciated that for simplicity and clarity of illustration, elements shown in the figures have not necessarily been drawn accurately or to scale. For example, the dimensions of some of the elements can be exaggerated relative to other elements for clarity, or several physical components can be included in one functional block or element.

### DETAILED DESCRIPTION

In the following detailed description, numerous specific details are set forth in order to provide a thorough understanding of the invention. However, it will be understood by those skilled in the art that the present invention can be practiced without these specific details. In other instances, well-known methods, procedures, and components, modules, units and/or circuits have not been described in detail so as not to obscure the invention.

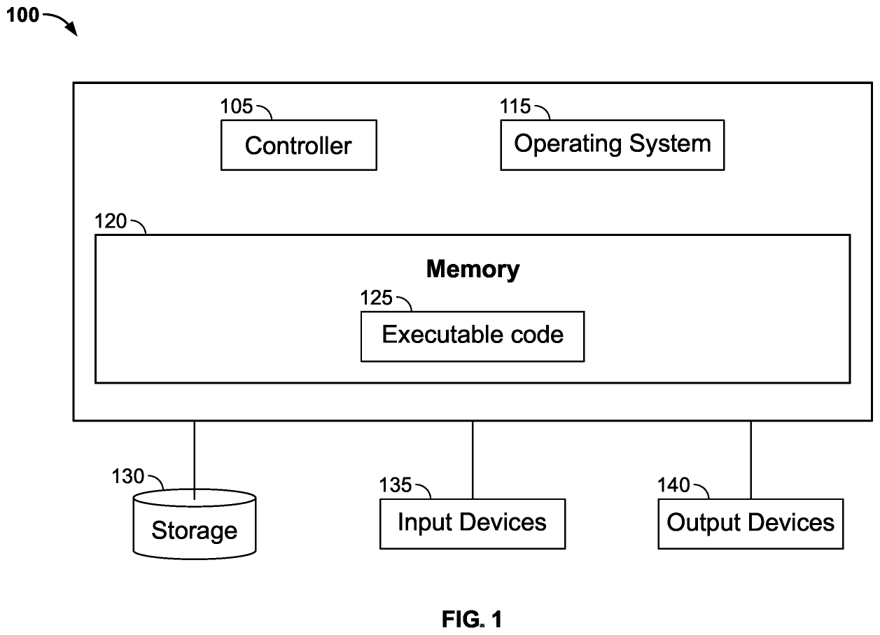

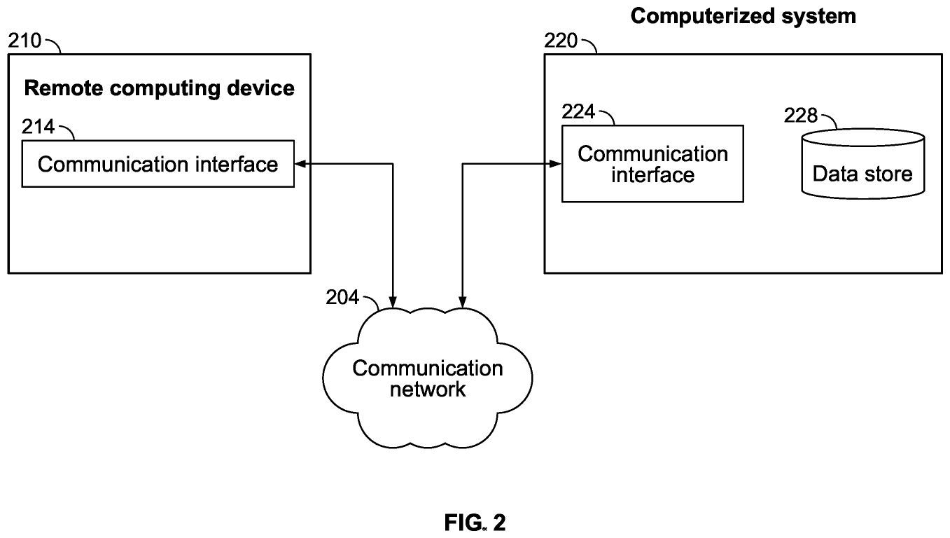

FIG. 1 shows a high-level block diagram of an exemplary computing device which may be used with embodiments of the invention. Computing device 100 may include a controller or processor 105 (or, in some embodiments, a plurality of processors) that may be, for example, a central processing unit processor (CPU), a chip or any suitable computing or computational device, an operating system 115, a memory 120, a storage 130, input devices 135 and output devices 140 such as a computer display or monitor displaying for example a computer desktop system. Each of the procedures and/or calculations discussed herein, and the modules and units discussed, such as for example those included in FIGS. 2-10, may be or include, or may be executed by, a computing device such as included in FIG. 1, although various units among these modules may be combined into one computing device.

Operating system 115 may be or may include any code segment designed and/or configured to perform tasks involving coordination, scheduling, arbitration, supervising, controlling or otherwise managing operation of computing device 100, for example, scheduling execution of programs. Memory 120 may be or may include, for example, a Random Access Memory (RAM), a read only memory (ROM), a Dynamic RAM (DRAM), a Synchronous DRAM (SD-RAM), a double data rate (DDR) memory chip, a Flash memory, a volatile memory, a non-volatile memory, a cache memory, a buffer, a short term memory unit, a long term memory unit, or other suitable memory units or storage units. Memory 120 may be or may include a plurality of, possibly different memory units. Memory 120 may store for example, instructions (e.g. code 125) to carry out a method as disclosed herein, and/or a data store of a plurality of data items describing one or more remote computing devices as further disclosed herein.

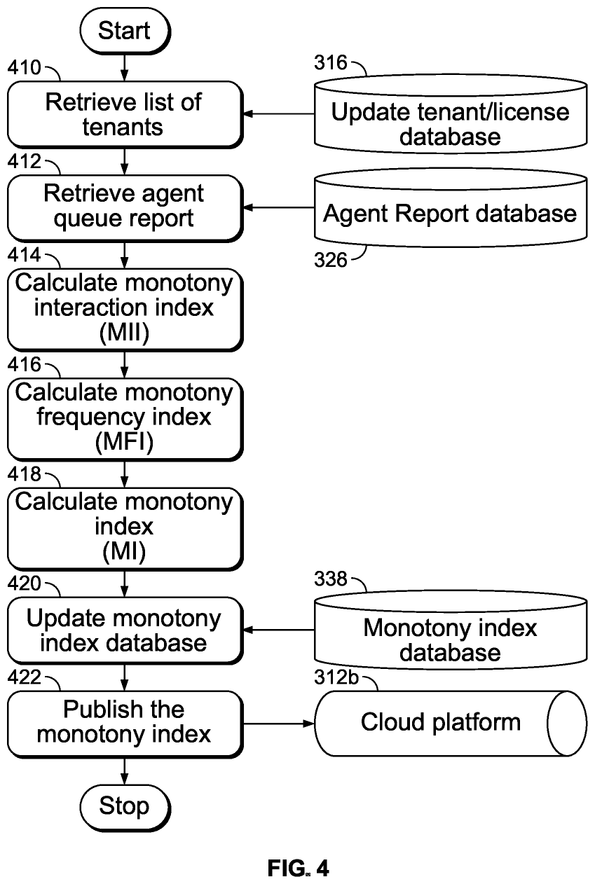

Executable code 125 may be any executable code, e.g., an application, a program, a process, task or script. Executable code 125 may be executed by controller 105 possibly under control of operating system 115. For example, executable code 125 may be one or more applications performing methods as disclosed herein, for example those of FIGS. 4-10 according to embodiments of the invention. In some embodiments, more than one computing device 100 or components of device 100 may be used for multiple functions described herein. For the various functions described herein, one or more computing devices 100 or components of computing device 100 may be used. Devices that include components similar or different to those included in computing device 100 may be used, and may be connected to a network and used as a system. One or more processor(s) 105 may be configured to carry out embodiments of the invention by for example executing software or code. Storage 130 may be or may include, for example, a hard disk drive, a floppy disk drive, a Compact Disk (CD) drive, a CD-Recordable (CD-R) drive, a universal serial bus (USB) device or other suitable removable and/or fixed storage unit. Data describing one or more remote computing devices, as well as additional and/or different data items, may be stored in a storage 130 and may be loaded from storage 130 into a memory 120 where it may be processed by controller 105. In some embodiments, some of the components shown in FIG. 1 may be omitted.

Input devices 135 may be or may include a mouse, a keyboard, a touch screen or pad or any suitable input device. It will be recognized that any suitable number of input devices may be operatively connected to computing device 100 as shown by block 135. Output devices 140 may include one or more displays, speakers and/or any other suitable output devices. It will be recognized that any suitable number of output devices may be operatively connected to computing device 100 as shown by block 140. Any applicable input/output (I/O) devices may be connected to computing device 100, for example, a wired or wireless network interface card (NIC), a modem, printer or facsimile machine, a universal serial bus (USB) device or external hard drive may be included in input devices 135 and/or output devices 140.

Embodiments of the invention may include one or more article(s) (e.g. memory 120 or storage 130) such as a computer or processor non-transitory readable medium, or a computer or processor non-transitory storage medium, such as for example a memory, a disk drive, or a USB flash memory, encoding, including or storing instructions, e.g., computer-executable instructions, which, when executed by a processor or controller, carry out functions, methods and procedures as disclosed herein.

Memory or memory units 120 may include a data store of, e.g., a plurality of data items describing one or more of the remote computing devices, or data items recorded from a remote computer or a plurality of remote computers, such as further disclosed herein. It should be noted that a plurality of physically separate computer systems and/or computational resources which may or may not correspond to the architecture of system 100 (and may include for example ones provided via cloud platforms and/or services) may be for example connected via a data or communication network as a multi-memory and/or processor system, which may be used in some embodiments of the invention. Those skilled in the art may recognize that a plurality of computer system architectures may be used in different embodiments of the invention.

Embodiments of the invention may provide a method for identifying monotony in a computerized-system or device and/or in a system of a plurality of remotely connected such systems or devices. For example, in a computerized system including a processor or a plurality of processors, a communication interface to communicate via a communication network with a plurality of remote computing devices, and a memory including a data store of a plurality of data items describing, e.g., tasks executed by or involving the remote computing devices, embodiments of the invention may be used to select or choose a plurality of remote computers or computing devices based on the stored data items; calculate a plurality of monotony indices for the selected or chosen computing devices based on a plurality of tasks and corresponding time windows (in which, for example, the tasks were performed or executed); and automatically document, publish, or store calculated monotony indices in a database, which may involve, for example, changing fields included in the database, and/or changing and/or updating and/or generating metadata linked to the database.

Embodiments of the invention may involve sending or transmitting a plurality of data items (which may for example constitute or represent agent activity, task sequence and/or schedule, task performance statistics, and the like) from a plurality of remote computing devices and/or receiving or gathering such data items via for example a communication or data network, and receiving and/or storing and/or analyzing, by a computerized system (which may conform e.g. to the specifications of system 100) data representing the remote computers, and/or a plurality of remotely-connected computer systems. As further discussed herein, embodiments of the invention may include a computerized system including for example a plurality of processors, a communication interface (such as for example a NIC) to communicate via a communication network with a plurality of remote computing devices which may be for example associated a plurality of agents, and a memory including a data store of a plurality of data items describing the plurality of remote computing devices. Embodiments may thus allow better provisioning of data such as interactions to computer systems, avoiding and/or preventing negative performance impacts (e.g., due to attrition), identifying opportunities and/or needs for revising and/or improving task scripts (such as, for example, introducing caller self-service systems to execute tasks for which significant monotony was identified), and optimizing working schedules of working entities such that desirable performance and output quality may be achieved.

In the present disclosure, a contact center will be used as a non-limiting example relating to a particular working unit and/or entity network structure which may utilize embodiments of the invention at hand. Those skilled in the art will recognize, however, that different embodiments may generally be used for various kinds of remotely connected computer systems, which may not necessarily be limited to computer systems operated by a plurality of agents in a contact or call center environment. The contact center example in the present disclosure should thus be considered as non-limiting, and terms such as “agent” (and/or “caller”, “supervisor”, “customers”, and the like) may be used interchangeably with a computer system among a plurality of remotely connected computer systems (or simply “remote computers”) which may communicate over a data or communication network.

FIG. 2 illustrates a remote computer device connected via a communication or data network to a computerized system which may be used in some embodiments of the invention. Remote computer 210, which may for example be operated by an agent in a contact center, may execute tasks or interactions as described herein, and may be controlled by a remote system such as system 220 by for example having tasks or interactions sent to it, or a schedule of tasks created for it. For example, computer 210 may send or transmit, over communication or data network 204, a plurality of data items (which may for example be or include a plurality of data and metrics—such as, e.g., agent queue reports which may for example be associated with a given agent or a plurality of agents as further discussed herein—and data which are part of interactions, such as e.g. audio data as part of a voice over internet protocol (VOIP) call with a customer; customer data; customer account data; etc.) to computerized system 220—which may for example conform to the architecture of system 100, and include a plurality of components as further described herein, in order to carry out various steps and/or procedures according to some embodiments of the invention as further discussed herein. In some embodiments, computerized system 220 may additionally perform a plurality of operations including for example sending and/or transmitting and/or collecting and/or receiving data (such as for example processed data and/or calculated results) to or from additional remote computers or computerized systems (which may include for example a cloud-based database or remote services as further described herein). Those skilled in the art may recognize that additional and/or alternative remote and/or computerized systems and/or network and connectivity types may be included in different embodiments of the invention.

In some embodiments of the invention, remote computer 210 and computerized system 220 may communicate via data or communication network 214 via appropriate communication interfaces 214 and 224, respectively—which may be for example NICs or network adapters as known in the art. Computerized system 220 may include a data store 228 which may for example include a plurality of data items including, but not limited to, ones describing one or more remote computing devices and/or a plurality of tasks or interactions involving a plurality of remote computers or computing devices and associated with interaction or task types, e.g., as further discussed herein.

Embodiments of the invention may include creating and/or establishing and/or using a plurality of agent queue reports, which may contain data and metrics describing agent activity. In some embodiments, agent queue reports may be created on a regular basis (e.g., periodically, every X minutes) and may provide call or interaction statistics and/or summary data for a given computer-based tasks or interactions involving, for example for a given caller or agent, or a plurality of callers or agents—based on, e.g., data provided by or extracted from an automatic call distribution (ACD) system in a contact center, and/or on data reported by agents themselves. A non-limiting example agent queue report for a given task or interaction may take, e.g., the following form:

```
{
  “Agent-Queue-Report”: {
    “Queue Value”: “10503561”,
    “QueueName”: “Inbound WW”
    “IsOutbound”: “false”.
    “AgentValue”: “244397”,
    “AgentId”: “dc386619-0ade-4afa-be5c-c7f0737d27d4”,
    “Handled”: “1”,
    “HandledTime”: “117”,
    “WorkTime”: “30”,
    “QueueDelayTime”: “0”,
```

where notable variables include, e.g., “QueueValue” as an identifier describing a queue in which the task or interaction was placed (the number 10503561 may denote, for example, a queue defined by a particular field of knowledge or skill which the handling agent should possess, such as “hardware support”); a name given to the queue under consideration; “IsOutbound” as a variable describing whether the interaction under consideration is inbound (“IsOutbound”=0) or outbound (“IsOutbound”=1); a plurality of agent identifiers (Value/ID); a variable describing whether the task or interaction was handled (“Handled”=1) or not (“Handled”=0); an interaction handling time and a work time (e.g., in minutes) dedicated to the interaction itself (which may be, e.g., a phone call), or to working on a task or plurality of tasks related but not included in the interaction itself, respectively (such times may, for example, be reported by the handling agent); and a queue delay time describing the amount of time (e.g., in seconds) during which the task or interaction was waiting in the queue and/or put on hold before being handled or fully handled. A task or interaction as discussed herein may be a combination of computer-based and manual or human processes, such as actions of a worker or agent using a computer to interact with another person, (e.g. as part of a conversation, video call, text message exchange, or combination of these or other communications), etc. For example, a task may be or may include using an agent terminal, including customer database software, to communicate with a customer over VOIP chat regarding a certain issue, such as, e.g. a technical support issue.

In some embodiments of the invention, a plurality of data items such as, e.g., agent queue reports may be generated in predetermined time intervals (e.g., every X minutes) to, e.g., summarize agent activity during that time. In cases where contact or caller handling is reported (e.g., manually, by the handling agent), contacts or callers may be, for example, counted and/or considered and/or included in the report summarizing the time interval during which the corresponding task, call or interaction was terminated.

Agent queue reports may take different formats according to different embodiments of the invention. For example, agent queue reports may be produced in JSON format in order to ensure compatibility with appropriate workforce management (WFM) computer programs or applications (such as for example the CXone platform by Nice Ltd.). It should be noted, however, that alternative formats and variables may also be used.

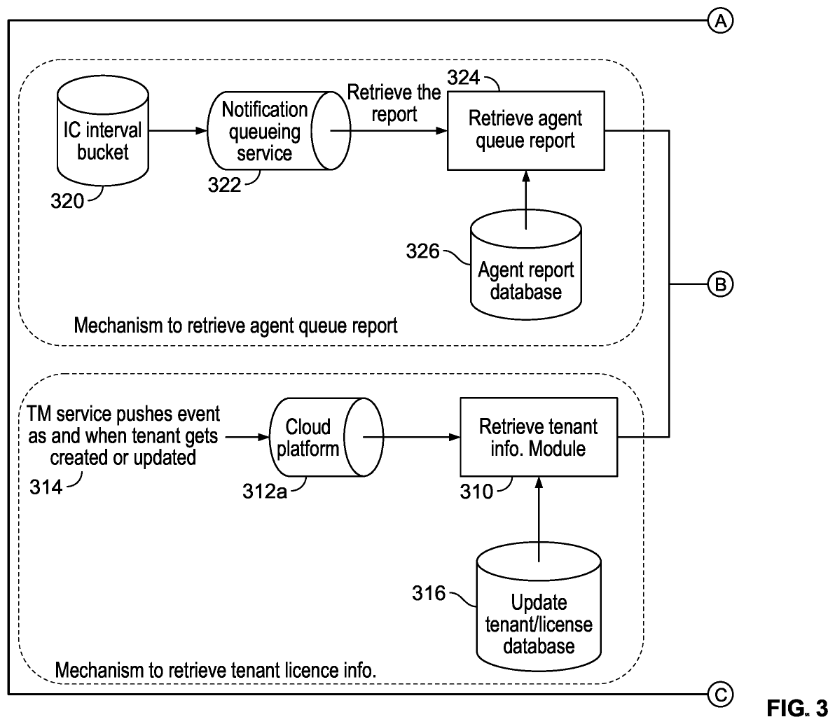

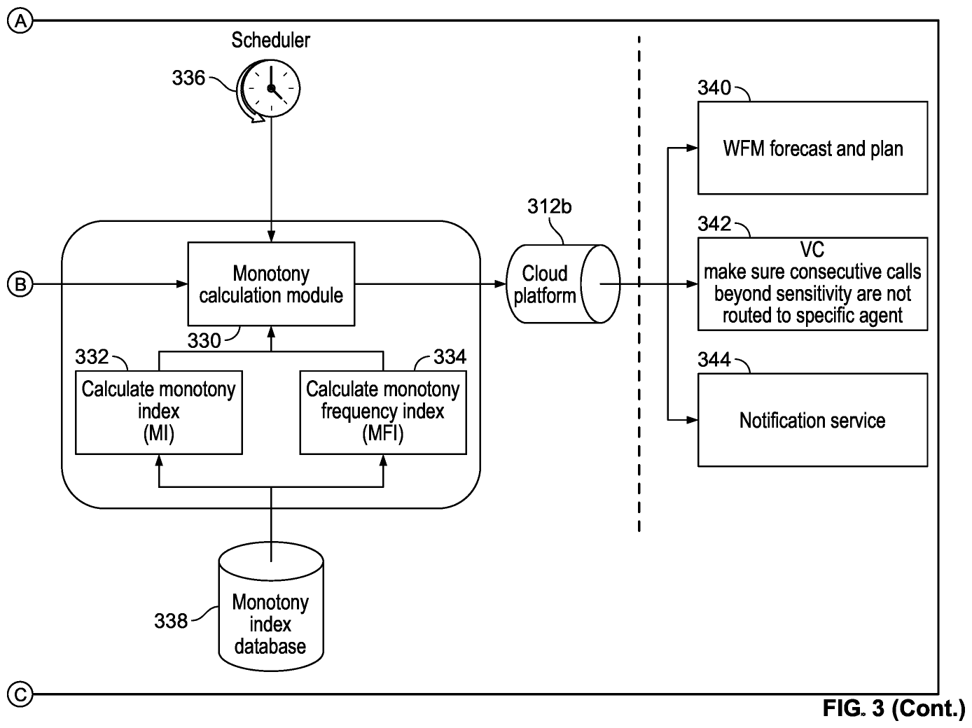

FIG. 3 is a high-level block diagram which illustrates an example architecture of a system for identifying and/or quantifying monotony according to some embodiments of the invention. Embodiments may include mechanisms for retrieving tenant license information and/or data items. In some embodiments, a “retrieve tenant information” (RTI) module 310 may, for example, use a tenant management application programming interface (API) for retrieving a list of tenants from a cloud-based platform 312a, such as for example Amazon Kinesis, or from data streams provided by such platform. In some embodiments, a tenant management (TM) service 314 may transmit or provide tenant information, which may be for example a Kinesis event stream, at any point where a new tenant is created and/or when existing tenant information gets updated Embodiments may accordingly receive, for example, a Kinesis stream event including license information, for example at a given instance of tenant creation/updating of tenant information, and may use information provided from both tenant management API and Kinesis streams to keep, maintain, or update a license database of tenants 316 for whom monotony index calculations may be enabled. In some embodiments, license or tenant database 316 may include entries such as for example:

{
TenantID: UUID
LicenseID: n
}

Where UUID is a universally unique identifier and n is a license identifier, although additional entries and/or information may be included as well. Additional procedures and/or approaches for retrieving tenant and/or license information may be used in different embodiments of the invention. TM service 314 may thus be used to enable or disable the calculation of monotony indices, e.g., for selected agents, based on the retrieved tenant and/or license information.

Embodiments may include or involve mechanisms for retrieving agent data and metrics such as for example agent queue reports as considered herein. For example, retrieving procedures or protocols may search or query an appropriate database, or a plurality of databases, for agent data and metrics which may be used as input for monotony index calculations as demonstrated herein. Databases which may be queried by embodiments of the invention may, for example be included or be part of existing WFM systems—which may include a dedicated database or data store such as an interval bucket 320 to store task, interaction or event data or data items, and a corresponding message or notification queuing service 322 (such as for example Amazon SQS), which may be triggered or activated by the creation of a data item or object in interval bucket 320, e.g., to communicate with computer programs or modules external to the WFM program as known in the art. In some embodiments, a “retrieve agent queue report” (RAQR) module 324 may be coupled to notification queuing service 322 and fetch or retrieve a plurality of agent queue reports based on notifications or messages received from notification queuing service 322. For example, notification queuing service 322 may notify RAQR module 324 that new data was stored in interval bucket 320, and RAQR module 324 may accordingly query or search interval bucket 320 for a plurality of data items which may be used to create or prepare an agent queue report (for example according to the example format considered herein). RAQR module 324 may then fetch or receive the queried data items and store them in a dedicated agent report database 326 (which may be for example organized as a table, although alternative database formats may be used in different embodiments of the invention). In some embodiments, the searching or querying of interval bucket 320 and/or the receiving and storing of data items in agent report database 326 may be performed periodically (e.g., every X minutes, or following X messages or notifications from notification queuing service 322). Additional procedures and/or approaches for retrieving and/or creating agent reports may be used in different embodiments of the invention.

A plurality of agents or remote computers may be chosen or selected by embodiments of the invention for monotony assessment or evaluation based on, for example, existing or stored agent queue reports and/or data items and a plurality of conditions and/or criteria and/or predetermined thresholds. For example, embodiments may choose or select a plurality of agents for which a queue delay time exceeding a predetermined threshold (e.g., X hours) was measured in X consecutive days. In addition, embodiments may be configured to create or generate new data items (such as, e.g., reports describing the execution or performing of tasks by remote computers, and/or data items including task scheduling instructions as described herein) based on existing, stored data items. Using the same example, data items such as for example agent queue reports may be generated on an X-hour basis instead of a Y-hour basis (where, e.g., Y>X) if predetermined conditions or criteria are met (such as for example measuring queue delay times for a plurality of agents which exceed a predetermined threshold). It should be noted, however, that alternative conditions and/or criteria and/or predetermined thresholds for selecting agents for monotony assessment or evaluation, and for generating new data items and/or agent queue reports, may be used in different embodiments of the invention.

Embodiments may include a monotony calculation module 330 which may be used for calculating or computing monotony indices for a plurality of selected agents, for example based on a plurality of documented tasks or interactions and corresponding time windows or timeframes as described herein. In some embodiments, the calculating or computing of a given monotony index (MI) by monotony calculation module 330 may include calculating a plurality of subcomponents, such as for example a task type or monotony interaction index (MII) 332 and a time window or monotony frequency index (MFI) 334, which may for example reflect different measures of monotony as described herein. MI calculations may, for example, be executed on a regular basis (e.g., periodically, every X minutes) using scheduler 336, and calculated or computed MIs may subsequently be automatically documented, published, or stored in a dedicated monotony index database 338 as described herein.

In some embodiments, calculated, documented or stored MIs may be sent or transmitted to could-based platform 312b, such as for example Amazon Kinesis as described herein, and may be further sent or transmitted (e.g., as a Kinesis event stream) to potential data utilizer computer programs and/or applications including for example WFM applications 340, virtual cluster (VC) and/or ACD applications 342, and notification services 344 (which may be used, for example, to send or transmit an alert to a supervisor who may, e.g., decide to change the task schedule for a given agent based on calculated or computed monotony indices) which may for example be combined with or implemented in some embodiments of the invention. Additional and/or alternative data utilizer programs and/or applications may be used or included in different embodiments of the invention, and alternative architectures including different modules to generate and/or fetch data and/or information, and/or create agent reports, and/or calculate or compute MIs, and/or send or transmit calculated indices and/or related information to data utilizers may be used in different embodiments.

FIG. 4 is a flow diagram illustrating an example procedure for identifying and/or quantifying monotony according to some embodiments of the invention. In step 410, embodiments may fetch or retrieve a list of tenants and/or tenant licenses, for example following the updating of a tenant or license database as described herein. Embodiments may then fetch or retrieve a plurality of agent queue reports and/or agent data and metrics from a dedicated database, for example for selected tenants and/or licenses, which may, e.g., conform to the example agent queue report format demonstrated herein (step 410). Based on retrieved agent queue reports and/or agent data and metrics (which may be used, for example, for selecting agents for monotony assessment or evaluation, or for the generating of new data items and/or agent queue reports as discussed herein), embodiments may calculate a task type or MII index (step 414) and a time window or MFI index (step 416), which may subsequently be used to calculate a final MI as further described herein (step 418). Embodiments may then update a dedicated monotony index database 338, by, for example, automatically documenting, publishing, or storing the calculated MI (step 420)—and send and/or transmit and/or publish the calculated MI (for example to cloud platform 312b, as a Kinesis stream including monotony information) such that it may be used by potential data utilizer computer programs and/or applications as described herein (step 422). It should be noted that alternative workflows and/of sequences of steps may be used in different embodiments.

In some embodiments, some or all of steps included, e.g., in FIG. 4 may be performed periodically, e.g., every X hours—in order to enable optimized and desirable assessment, evaluation, and monitoring of monotony for a plurality of remote computers (e.g., reflecting a balance between desirable information availability and the computational cost associated with it).

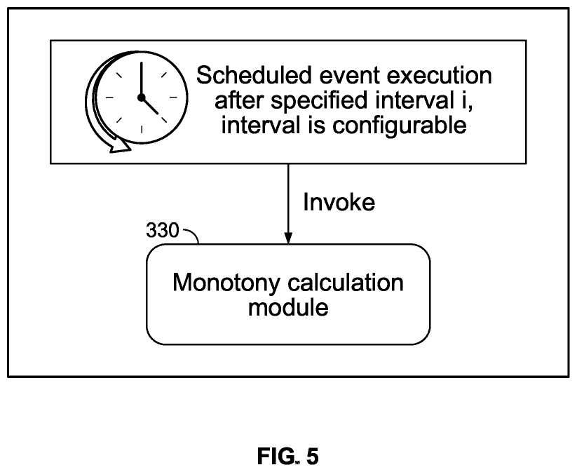

FIG. 5 illustrates an example scheduled execution of a procedure for identifying and/or quantifying monotony by a scheduler according to some embodiments of the invention. In some embodiments, a scheduled and/or periodic event execution based on a specified time interval or time window of length i (such as for example i=X minutes or hours) may invoke the calculation of MIs—e.g., according to the example workflow illustrated in FIG. 4—by triggering and/or activating monotony calculation module 330. In some embodiments, time interval or window length i might be configurable and/or dynamically modifiable (for example to invoke more frequent, periodic calculations of MIs according to the frequency of updating of agent report database 326 as described herein). Similarly, and in addition to MI calculation and/or documenting and/or storing of MIs, the scheduler or scheduling module may determine the periodic sending or transmitting of data items to potential data utilizers as described herein. In some embodiments, the periodic event may be executed by a scheduler or scheduling module, which may be configured to read metadata and/or data items linked to MI database 338 (such as, e.g., data and/or information items describing MI states over a range of X executed schedules) and accordingly determine a rate or a time window length separating, e.g., subsequent calculations of MIs, as well as related procedures as described herein, based on the metadata or data items. For example, in the case where “unhealthy” MIs (see discussion regarding MI state herein) were calculated for three subsequent schedules for a given agent, the scheduler may read data and/or information items describing the corresponding states for calculated MIs and accordingly determine and/or automatically send an instruction for calculating MIs, as well as for generating agent queue reports by the appropriate system components, according to a maximal rate or periodic execution (e.g., each X hours). Similarly, in case there are no three subsequent schedules for which “unhealthy” MIs were calculated within a predetermined time window (e.g., a week), the scheduler may read the relevant data and/or information items and determine and/or send an instruction for calculating MIs and/or for generating agent queue reports according to a default rate or time window (e.g., each 2X hours). Thus, the determined rate may be automatically and dynamically modified in some embodiments of the invention according to the reading of states by the scheduler (e.g., a reading may itself be performed periodically, e.g., every week; and the time window or rate of scheduled event execution may, for example, be determined as the maximal possible rate once subsequent “unhealthy” states are read by the scheduler). It should be noted, however, that alternative scheduling approaches based on various sources of data (such as for example a manually-defined quality management policy) may be used in different embodiments of the invention.

Task or interaction types as referred to herein may be defined and determined, for example, based on task or interaction details as documented in agent queue reports, or based on the processing of such interaction details (which may include, for example, a plurality of conditions and/or criteria and/or predetermined thresholds). For example, embodiments may define task or interaction types such that tasks or interactions having a duration longer than a predetermined threshold (e.g., X minutes) would be identified as belonging to type=1, and ones having a duration shorter than a predetermined threshold would be identified as belonging to type=2, and so forth. Similar attribution into types may be performed based on the number times a task or interaction was put on hold, the number or times a task or interaction was transferred to a different handling agent, the amount of time dedicated to working on a task related to a different task or interaction (which may be for example manually reported by the handling agent), or other possible characteristics. In addition, task or interaction types may be defined and determined based on combinations of task or interaction characteristics. For example, tasks or interactions longer than a predetermined threshold and having put on hold more than X times may be categorized as belonging to type=3, and so on. Alternative categorizations into types based on task or interaction details and/or data and/or information may be used in different embodiments of the invention.

In some embodiments, a task or interaction type may be determined, for example, according to an agent's skill used or reported (e.g., by the handling agent) as related to the task or interaction. Agent skills may, for example, be based on a quality and/or workforce management policy implemented in corresponding computer programs. Skills may include, for example, fields of knowledge (such as “computer hardware”) as well as fields of expertise (such as “sales”. “technical support”, and the like). Alternative or additional skills may be used or included in different embodiments of the invention. In some embodiments, tasks or interactions may be assigned a type based on the substantive work performed by or required from the agent in the task (which may be related to or overlap the skills used), e.g. sales work, billing work, etc.

Embodiments may calculate MIIs which may be used as a subcomponent of final MI, and may reflect or quantify a relative weight of tasks of a given type among a plurality of tasks—which may be for example the maximum number of tasks or interactions of a single type (or associated with a particular skill) which were handled by the agent within a given time interval or period. MIIs may be calculated, for example, according to example eq. 1:

$$MII = Max ( \frac{{n}_{1}}{{n}_{tot}} , \frac{{n}_{2}}{{n}_{tot}} , … , \frac{{n}_{N}}{{n}_{tot}} ) * 10 \qquad ( eq . 1 )$$

where n_{N} is the number of tasks or interactions belonging to type N, and nₜₒₜ is the total number of tasks or interactions handled by the agent during a given time interval.

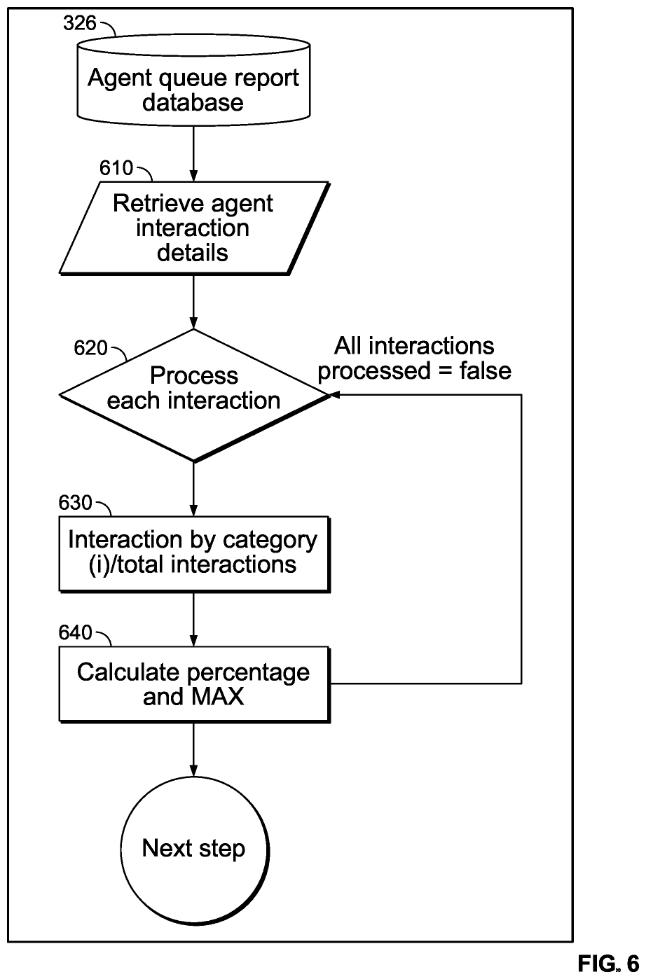

FIG. 6 is a flow diagram of an example MII calculation procedure according to some embodiments of the invention. Embodiments may search or query agent queue report database 326 for task or interaction details, which may be documented for example in an agent queue report as demonstrated herein (step 610). Each of a plurality of tasks or interactions handled by a given agent within a time window or timeframe may then be processed (step 620) based on retrieved task or interaction details, and embodiments may count the number of tasks or interactions belonging to a specific category, to calculate their fraction or percentage among the total number of tasks or interactions handled by the agent within that time window (step 630). A maximum fraction or percentage reflecting the largest number of tasks or interactions belonging to a specific category among all tasks or interactions handled by the agent within the time window or timeframe under consideration may be given as the output of an MII calculation (step 640).

In addition to MIIs, embodiments may calculate MFIs as an additional subcomponent of final MIs. MFIs may be considered as a measure for quantifying the consecutive handling of tasks or interactions belonging to the same type, or a relative weight of consecutive tasks of a given type, within a time window or a plurality of time windows or timeframes. MFIs may be calculated, for example, according to example eq. 2:

$$MFI = 10 ( \frac{F C}{T S - 1} ) \qquad ( eq . 2 )$$

where the frequency count (FC) may be calculated using, for example, eq. 3:

$${\sum }_{i = 0}^{N - 1} ( ( {\sum }_{j = i + 1}^{w} Category of interaction ( i ) = Category of interaction ( j ) \to x = x + 1 ) \qquad ( eq . 3 )$$

$$\to \{ \begin{matrix}x = w & FC = FC + 1 \\ x \neq w & do nothing\end{matrix} )$$

(meaning, each task or interaction i is compared to subsequent tasks or interactions j to check whether the type of i is identical to that of j; for each task or interaction i, if there is a subsequent task or interaction j belonging to the same type, a variable x is incremented by 1; then, if x equals a predetermined threshold w, then the FC variable is incremented by 1.)
and where the time window, timeframe, or time slot (TS) may be calculated using, for example, eq. 4:

TS=P/R (eq. 4)

in which P is period of time for which the MFI is calculated, and R is the granularity of task or interaction data or information availability, e.g., the frequency of generating agent queue reports used for calculating MFIs. Other or different formulas may be used.

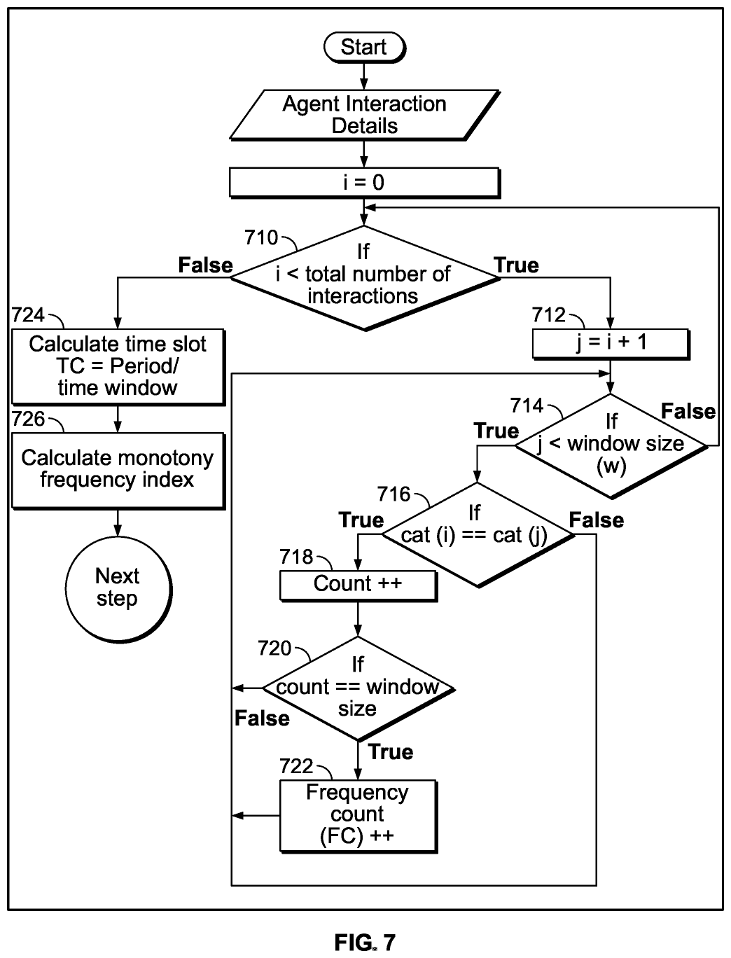

FIG. 7 shows a flow diagram of an example MFI calculation procedure according to some embodiments of the invention. Based on retrieved task or interaction details (such as for example agent queue reports) embodiments may begin the procedure at task or interaction index i=0 (e.g., beginning the procedure with the first task or interaction within the time interval or period) and go over all tasks or interactions within a given timeframe. In step 710, embodiments may check whether i is smaller than the total number of tasks or interactions. If so, embodiments may set index j as j=i+1 (step 712). It may then be checked whether j is smaller than a predetermined threshold or window w (step 714). In that case, embodiments may check whether the category of task or interaction i is identical to the category of task or interaction j (step 716). If the categories are identical, then a count variable (such as for example x in eq. 3) may be incremented by 1 (step 718). It may then be checked if the count variable equals predetermined threshold or window size w (step 720), and if so—an FC variable may be incremented by 1 (step 722). In case the conditionals of steps 716, 720 are found false, or following the incrementing of FC, embodiments may set j=j+1 and repeat steps 714-722, until the conditional of step 714 is found false—in which case embodiments may set i=i+1 (e.g., move on to the next task or interaction within the time period under consideration) and return to step 710. At the point where i equals the total number of tasks or interactions (meaning, e.g., that all tasks or interactions have been processed), embodiments may calculate TS (e.g., according to eq. 4; step 724), and then calculate an MFI (e.g., based on eq. 2 and preceding steps of the procedure; step 726).

In some embodiments, MFIs may be calculated according to the following example procedure and algorithm, which may include iteratively incrementing a plurality of “count” variables as described herein:

```
INPUTS: Agent Interaction Details, Window size w
Initialize Variable i = 0, Count = 0, FrequencyCount = 0
Start FOR Loop
  FOR i = 0
    IF i < Total number of interactions
      Initialize Variable j = i + 1
      Start FOR Loop
        IF j < Window size (w)
          IF Category of Interaction (i) is equal to Category of Interaction (J)
            Increment Count by 1
            IF Count is equal to Window Size
              Increment FrequencyCount by 1
        ELSE Break the loop (j)
    ELSE Break the loop (i)
Calculate Time SlotCalculate Monotony Frequency Index (MFI)
```

It should be noted, however, that alternative calculation algorithms and/or procedures (which may for example include iterative execution of steps and iteratively incrementing a plurality of variables) may be used in different embodiments of the invention.

Embodiments may calculate MIs for a plurality of agents, which may offer a general measure of monotony, or repetitiveness of tasks, within a given timeframe or period. In some embodiments, MIs may be calculated based on previously calculated MIIs and MFIs, for example based on the average of the two, according to example eq. 5:

$$MI = \frac{MII + MFI}{2} \qquad ( eq . 5 )$$

alternative formulas, e.g., in which different weights are given to MIIs and MFIs, may be used in different embodiments of the invention.

Embodiments may determine or compute an MI state for, e.g., a plurality of calculated MI based on various conditions and/or criteria and/or predetermined thresholds or ranges. An example scheme for determining an MI state is illustrated in Table 1:

TABLE 1

| # | MI Range | State |
|---|---|---|
| 1 | 0 to 3 | Healthy |
| 2 | 4 to 6 | Moderate |
| 3 | 7 to 10 | Unhealthy |

Where, e.g., “unhealthy” indicates high (and undesirable) level of monotony. Alternative schemas and/or procedure for determining an MI state may be used in different embodiments of the invention.

Calculated MIs may be processed and/or documented and/or published and/or stored (e.g., automatically) in monotony index database 338 for future use. In some embodiments, MI database entries may be organized or formatted to include a plurality of fields and data types, or to be linked to additional data sources and/or metadata for example according to example Table 2:

TABLE 2

| Field Name | DataType | Purpose |
|---|---|---|
| Id | String | Unique MI record id (uuid) |
| TenantId | String | Tenant id for which the monotony was |
| | | calculated |
| AgentId | String | Unique identifier for an agent GUID or |
| | | uuid |
| dateTime | Number | Timestamp of the monotony index |
| | | calculation |
| SkillName/SkillId | String | The skill associated with task or |
| | | interaction with highest MII |
| AgentQueueValue | JSON | The json object(s) obtained from an |
| | | agent queue report or a plurality of |
| | | reports |
| MonotonyIn- | Number | Value of monotony index (MI) |
| dexValue | | |
| State | String | State of MI (Healthy/Moderate/ |
| | | Unhealthy) |
| MII | Number | Value of monotony interaction index |
| | | (MII) |
| MFI | Number | Value of monotony frequency index |
| | | (MFI) |
| Period | Number | Period of time for which the MFI is |
| | | calculated |
| TimeSlot | Number | Time slot calculated as part of MFI |
| | | calculation |
| Timewindow | Number | granularity of task or interaction data |
| | | (e.g, frequency of agent queue reports) |

In some embodiments, the documenting and/or publishing and/or storing of calculated MIs in monotony index database 338 may include writing and/or changing and/or updating of a plurality of fields and/or metadata included or linked to monotony index database 338. It should be noted, however, that alternative formats and fields, as well as different data types, may be used in different embodiments of the invention. Metadata linked to the database may be or may include, for example, data items and/or elements and/or reports (which may for example be or include text files and/or JSON data objects) associated with and/or describing calculated MIs and/or MI states, which may be further sent or transmitted to potential data utilizers and/or determine the frequency of sending or transmitting elements to data utilizers by a scheduler or scheduling module as further described herein.

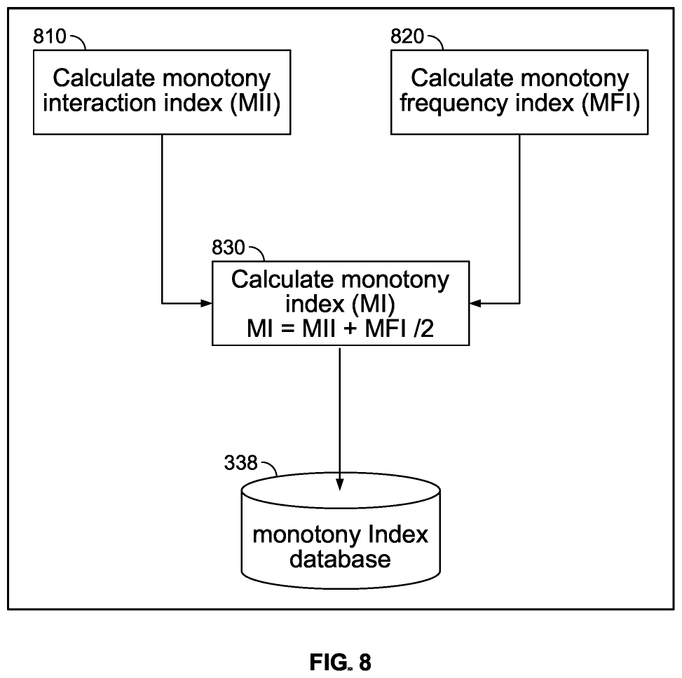

FIG. 8 is a flow diagram of an example MI calculation procedure according to some embodiments of the invention. An MII and an MFI may be calculated, for example, based on eqs. 1-4 and/or according to FIGS. 6-7 (steps 810 and 820). A final MI may then be calculated or derived from the previously calculated MII and MFI—for example as an average between the two and according to eq. 5 (step 830). Calculated MIs may then be automatically documented and/or published and/or stored in monotony index database 338, e.g., according to the example format in Table 2. It should once again be noted that alternative procedures and/or workflows for calculating monotony indices, as well as alternative formats and/or structures for MI database entries, may be used in different embodiments of the invention.

Calculated MIs and corresponding entries in monotony index database 338, as well as related data and/or information items (such as for example ones stored in report database 326 and/or tenant database 316) may be sent or transmitted to a plurality of data utilizer computer programs and/or applications. MIs and related data and/or information items may for example be sent or transmitted e.g., via communication network 204. In some embodiments, the sending or transmitting of MIs and/or related items to data utilizers may include first sending or transmitting items to an appropriate cloud-based component or platform, which may ensure data and/or information availability (e.g., within a given timeframe) for data utilizers. For example, in some embodiments, MIs and/or related items may be sent or transmitted as a Kinesis stream, to be available for, e.g., compatible WFM computer programs and applications, which may for example be configured to take subsequent actions to ensure optimization of monotony, such as for example disabling the scheduling of tasks of a given type, and/or calculating or determining future block scheduling options based on calculated MIs as further described herein. An example format of a simple Kinesis stream of calculated MIs may be:

```
{
  ″Id″: ″e616add3-b8f6-4681-85d3-75b16af3c552″,
  ″TenantId″: ″f69ea100-5ebd-4e00-89a8-9219b27a9b5a″,
  ″AgentId″: ″244397″,
  ″DateTime″: ″1656081401000″,
  ″SkillName″: ″Inbound WW″,
  ″MonotonyIndexValue″: ″5.5″,
  ″Period″: ″900″,
  “State”: “Moderate”
}
```

although other formats and/or contents may be used or included in different embodiments of the invention.

Embodiments may send or transmit a plurality of instructions to a remote computer, control the operations of a remote computer, or a plurality of remote computers—e.g., based on the documenting and/or the publishing of monotony indices and/or on additional input from data utilizer programs or applications—for example to automatically execute or assign a plurality of computer tasks and/or interactions and/or operations and/or procedures and/or programs on a remote computer. In some embodiments, sent or transmitted instructions and/or automatically assigned or executed operations, interactions, or procedures may be implemented in a block task scheduling framework as described herein.

Embodiments of the invention may provide a block task scheduling framework which may be for example integrated into various data consumer computer programs and applications, such as e.g., WFM applications. In such framework, sequences or “blocks” including a plurality of repetitive tasks or interactions may be, for example, assigned to an agent (e.g., executed via an agent's computer, thus controlling the remote computer) based on a plurality of factors such as, e.g., level of urgency, skills mastered by the agent, estimated value and/or cost, and the like—and for example be automatically executed by an agent or remote computer according to, or based on a determined or assigned schedule and corresponding instructions. A “block” may thus mean a fixed duration on an agent's schedule to be filled up with a plurality of tasks of a given type which may fit within that fixed duration.

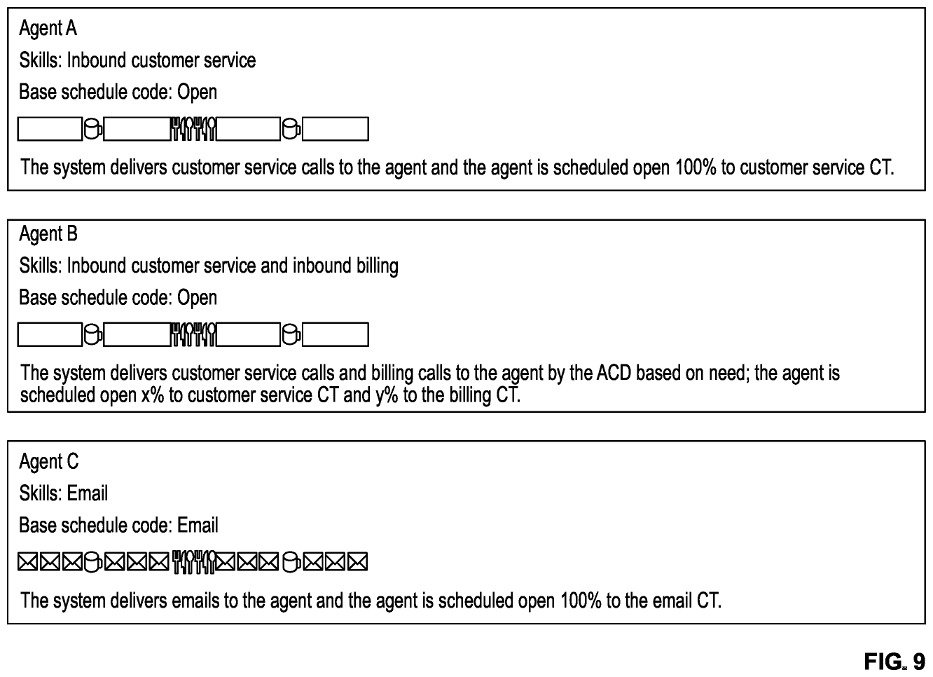

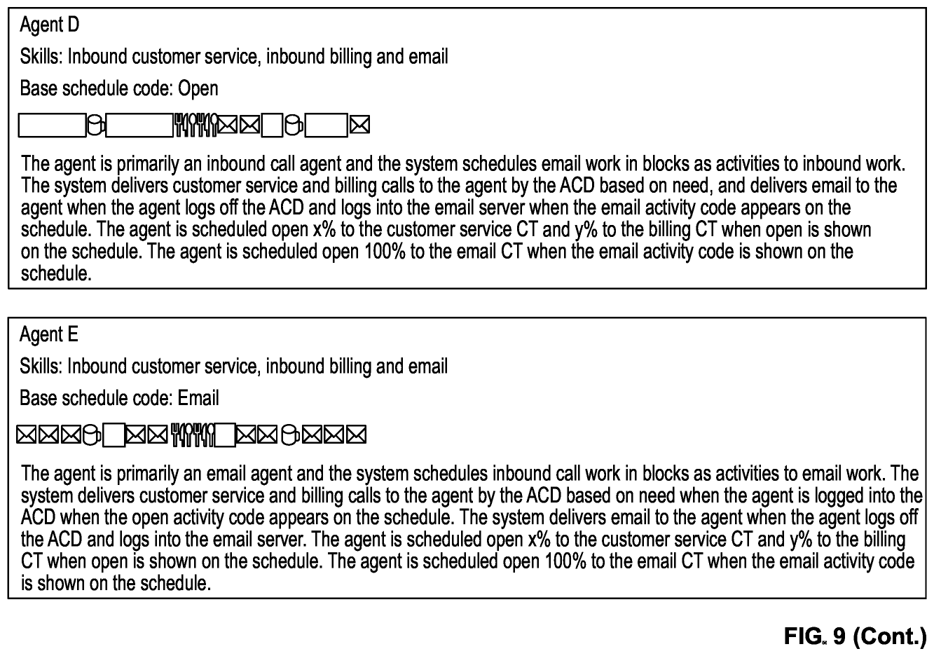

FIG. 9 depicts an example visualization of a block scheduling approach which may be used in some embodiments of the invention. Embodiments may assign a block or group of (e.g. repetitive) tasks or interactions belonging to the same given type, such as for example handling of email responses, inbound calls, technical support issues, and the like, to a schedule of a given agent or a plurality of agents—according to skills reported or found for the agent or agents under consideration. For example, for an agent having skills such as “inbound customer service”, “inbound billing” and “email” (sec, e.g., agent D in FIG. 9), embodiments may assign two blocks of email handling tasks, and leave the rest of the agent's schedule open to on-demand handling of customer service and billing tasks. As shown in FIG. 9, different blocks may be assigned to different agents according to their reported skills and based on, for example, a predetermined WFM policy which may determine, e.g., what tasks should be given priority (in the example of FIG. 9, email handling tasks may be considered prioritized over customer service and billing tasks in that the former always entail assigning a block to an agent's schedule, and are never handled alongside other tasks in an “open” schedule). Once assigned, tasks or interactions may be for example automatically executed by the handling agent or remote computer; for example interaction data (e.g. audio or video streams), customer database data, or other data, may flow through and be processed by the agent's computer. It should be noted that alternative prioritizations and corresponding criteria for block task scheduling procedures including a plurality of agents having different skills and fields of expertise may be used in different embodiments of the invention.

Embodiments of the invention may offer improved and optimized block scheduling of tasks for a plurality of agents, for example based on calculated or documented MIs (which may be imported or received, e.g., via Kinesis streams as described herein) as a schedule determining factor. The use of such MIs may improve the technology of scheduling computer-based tasks, e.g. the assigning of data-stream (e.g. interaction, text conversation) and other computer-based tasks. Embodiments of the invention may for example disable or forbid scheduling blocks (e.g. by causing or instructing a computer handling scheduling to perform scheduling accordingly) of tasks of a given type, which may be assumed to be a main contributor to the measured or calculated, undesirable level of monotony—based on the calculated MI or a plurality of calculated MIs. For example, embodiments may disable or forbid future scheduling of billing tasks for a given agent or remote computer, in case where an unhealthy MI was calculated for that agent or remote computer, or for a plurality of remote computers, and where billing tasks are the task type associated with or describing the majority of tasks, or a predetermined percentage of tasks handled by the agent or computer during the schedule for which the MI was calculated. Additionally or alternatively, future block scheduling options may be determined or produced for a given agent or remote computer, or for a plurality of remote computers, based on maximizing or minimizing “efficiency” of “inefficiency” functions for a set of block schedules or plurality of block scheduling options from which a schedule may be chosen and executed. In some embodiments, efficiency of inefficiency functions may include or incorporate calculated MIs as a variable or factor, e.g., among additional efficiency determining variables or factors. A set of corresponding weights or coefficients Ci (i=1, 2 . . . n) for different variables or factors included in a given efficiency function may be optimized to produce an “optimal schedule” for a given agent—where some or all of the Ci may be generated, determined or optimized, e.g., using a machine learning such as a neural-network-based model trained based on past efficiency data and/or metrics. An optimal schedule or scheduling options may thus be chosen from a set or a plurality of schedules or scheduling options based on maximization or minimization of the corresponding function once its underlying Ci coefficients are generated, determined or optimized. Those skilled in the art, however, would recognize that various efficiency functions of different functional forms, including different variables or factors (describing, for example an expected added value associated with a given task type, the type or specifications for a given agent or remote computer which may be associated with efficiency-related effects or outputs, and the like) may be used in different embodiments of the invention.

Once a schedule (such as for example an optimal block task schedule as illustrated in FIG. 9) has been determined, selected, or chosen, instructions may be sent or transmitted to a plurality of remote computers based on the chosen schedule. A plurality of remote computers may then automatically execute a plurality of tasks and/or procedures based on the determined schedule which may be for example an optimal scheduling option chosen based on maximizing or minimizing schedule efficiency or inefficiency functions as described herein, and/or based on comparing outputs or values calculated for a plurality of schedules or scheduling options using such functions, and/or using alternative efficiency measures and/or metrics.

Previous systems and methods for task scheduling, e.g., for agents in a contact center are focused, for the most part, on reducing manual labor in determining coherent and/or coordinated work schedules for a plurality of agents, and on avoiding redundancies among schedules of different agents while achieving the highest work output (e.g., for the contact center as a whole—including all agents). Such systems and methods, however, do not incorporate the relationship between monotony and task output into account, which is known to exist in realistic environments. Embodiments of the invention improve the technology of scheduling computer-based tasks, e.g. by allowing quantifying and documenting monotony using, for example, calculated MIs, and thus enable optimizing work or task output by embracing and applying more realistic and accurate protocols and/or procedures to schedule and task efficiency.

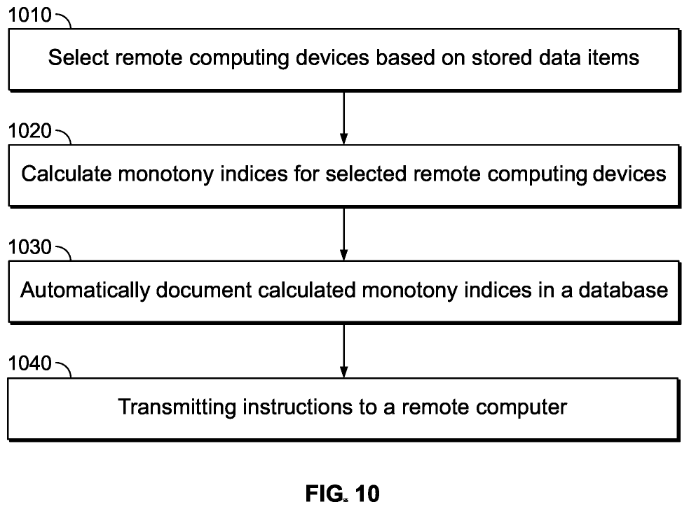

FIG. 10 is a flowchart depicting a method for controlling a computer system based on quantifying monotony and acting on that quantification according to some embodiments of the invention. In step 1010, a computer processor may be configured to select remote computing devices based on stored data items (which may be for example agent queue reports as described herein). Embodiments may then calculate monotony indices for selected remote computing devices based on, for example, tasks described in the stored data items and time windows during which the tasks were performed or executed (step 1020). The monotony index associated with a specific computer may be associated also with the person assigned to that computer, e.g. the agent associated with a computer. Embodiments may then automatically document calculated monotony indices in a database, which may include, e.g., changing fields included in the database, or metadata linked to the database (step 1030). In step 1040, a processor may then control a computer system based on the calculation or quantification of monotony, for example by sending or transmitting instructions to a remote computer. For example, a processor may assign computer-dependent tasks to a certain computer based on the calculated monotony index for that computer, or for the person associated with that computer. The assigned computer may then execute tasks or interactions. For example, interactions (e.g. including VoIP streams, video calls, etc.) may be assigned to a certain computer and that computer may control an interaction between an agent and customer, or a CRM session with the agent.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

In the foregoing detailed description, numerous specific details are set forth in order to provide an understanding of the invention. However, it will be understood by those skilled in the art that the invention can be practiced without these specific details. In other instances, well-known methods, procedures, and components, modules, units and/or circuits have not been described in detail so as not to obscure the invention. Some features or elements described with respect to one embodiment can be combined with features or elements described with respect to other embodiments.

Although embodiments of the invention are not limited in this regard, discussions utilizing terms such as, for example, “processing,” “computing.” “calculating.” “determining,” “establishing”, “analyzing”, “checking”, or the like, can refer to operation(s) and/or process(es) of a computer, a computing platform, a computing system, or other electronic computing device, that manipulates and/or transforms data represented as physical (e.g., electronic) quantities within the computer's registers and/or memories into other data similarly represented as physical quantities within the computer's registers and/or memories or other information non-transitory storage medium that can store instructions to perform operations and/or processes.

The term set when used herein can include one or more items. Unless explicitly stated, the method embodiments described herein are not constrained to a particular order or sequence. Additionally, some of the described method embodiments or elements thereof can occur or be performed simultaneously, at the same point in time, or concurrently.

What is claimed is:

1. A method for controlling a computer system based on quantifying repetitive computer-based tasks, the method comprising:
in a computerized-system comprising one or more processors, a communication interface to communicate via a communication network with one or more remote computing devices, and a memory including a data store of a plurality of data items describing one or more of the remote computing devices, wherein one or more of the data items describe one or more tasks executed by one or more of the remote computing devices, the one or more tasks associated with one or more tasks types:
selecting, by one or more of the processors, one or more of the remote computing devices based on one or more of the stored data items;
calculating, by one or more of the processors, one or more monotony indices for one or more of the selected remote computing devices based on one or more of the tasks and one or more time windows; and
automatically documenting one or more of the calculated monotony indices in a database, the documenting including changing one or more of: fields included in the database, or metadata linked to the database.

2. The method of claim 1, wherein the calculating of one or more monotony indices comprises calculating one or more task type indices, each task type index to quantify a relative weight of one or more of the tasks of a given type among one or more of the tasks.

3. The method of claim 1, wherein the calculating of one or more monotony indices comprises calculating one or more time window indices, each time window index to quantify a relative weight of one or more consecutive tasks of a given type within one or more time windows.

4. The method of claim 1, comprising generating one or more reports, the one or more reports describing the execution of tasks by one or more of the remote computing devices, based on at least one of: one or more of the stored data items, one or more conditions, and one or more predetermined thresholds.

5. The method of claim 4, comprising determining a time window length based on one or more of the data items; and
wherein at least one of: the generating of one or more reports, the selecting of one or more of the remote computing devices, the calculating of one or more monotony indices, and the documenting of one or more of the calculated monotony indices is performed periodically based on the time window.

6. The method of claim 1, comprising transmitting one or more instructions to a remote computer based on the documenting of one or more of the calculated monotony indices, the one or more instructions to automatically execute at least one computer operation on the remote computer.

7. The method of claim 6, comprising minimizing one or more inefficiency functions for one or more block scheduling options; and
choosing an optimal scheduling option based on the minimization, wherein the transmitting one or more instructions is performed based on the chosen optimal scheduling option.

8. The method of claim 7, wherein one or more of inefficiency functions comprise one or more coefficients; and wherein the method comprises generating, using a neural network, one or more of the coefficients.

9. A computerized system for controlling a computer system based on quantifying repetitive computer-based tasks, the system comprising:
one or more processors,
a communication interface to communicate via a communication network with one or more remote computing devices, and
a memory including a data store of a plurality of data items describing one or more of the remote computing devices, wherein one or more of the data items describe one or more tasks executed by one or more of the remote computing devices, the one or more tasks associated with one or more tasks types;
wherein the one or more processors are to:
select one or more of the remote computing devices based on one or more of the stored data items;
calculate one or more monotony indices for one or more of the selected remote computing devices based on one or more of the tasks and one or more time windows; and
automatically document one or more of the calculated monotony indices in a database, the documenting including changing one or more of: fields included in the database, or metadata linked to the database.

10. The system of claim 9, wherein the calculating of one or more monotony indices comprises calculating one or more task type indices, each task type index to quantify a relative weight of one or more of the tasks of a given type among one or more of the tasks.

11. The system of claim 9, wherein the calculating of one or more monotony indices comprises calculating one or more time window indices, each time window index to quantify a relative weight of one or more consecutive tasks of a given type within one or more time windows.

12. The system of claim 9, wherein the one or more processors are to generate one or more reports, the one or more reports describing the execution of tasks by one or more of the remote computing devices, based on at least one of: one or more of the stored data items, one or more conditions, and one or more predetermined thresholds.

13. The system of claim 12, wherein the one or more processors are to determine a time window length based on one or more of the data items; and
wherein at least one of: the generating of one or more reports, the selecting of one or more of the remote computing devices, the calculating of one or more monotony indices, and the documenting of one or more of the calculated monotony indices is performed periodically based on the time window.

14. The system of claim 9, wherein the one or more processors are to transmit one or more instructions to a remote computer based on the documenting of one or more of the calculated monotony indices, the one or more instructions to automatically execute at least one computer operation on the remote computer.

15. The system of claim 14, wherein the one or more processors are to:
minimize one or more inefficiency functions for one or more block scheduling options; and
choose an optimal scheduling option based on the minimization; and
wherein the transmitting one or more instructions is performed based on the chosen optimal scheduling option.

16. The system of claim 15, wherein one or more of inefficiency functions comprise one or more coefficients; and wherein the one or more processors are to generate, using a neural network, one or more of the coefficients.

17. A method for identifying monotony, the method comprising:
in a computerized-system comprising one or more processors, a communication interface to communicate via a communication network with one or more remote computing devices, and a memory including a data store of a plurality of data items describing one or more of the remote computing devices, wherein one or more of the data items describe one or more interactions involving one or more of the remote computing devices, the one or more interactions associated with one or more interaction types:
computing, by one or more of the processors, a monotony index for a remote computing device based on one or more of the interactions and one or more timeframes; and
automatically publishing one or more of the calculated monotony indices, the publishing including changing one or more of: fields included in a database, or metadata linked to the database.

18. The method of claim 17, wherein the computing of one or more monotony indices comprises calculating one or more monotony frequency indices, each monotony frequency index quantifying a consecutive handling of tasks belonging to the same type within one or more timeframes.

19. The method of claim 17, comprising sending one or more instructions to a given remote computer based on the publishing of one or more of the monotony indices, the one or more instructions to automatically assign at least one interaction to the remote computer.

20. The method of claim 19, comprising comparing one or more values calculated using inefficiency functions for one or more scheduling options; and
selecting a scheduling option based on the comparison, wherein the sending of one or more instructions is performed based on the selected scheduling option.
